(19) United States
(12) Patent Application Publication
(10) Pub. No.: US 2023/0375037 A1
(43) Pub. Date: Nov. 23, 2023

(54) MOVING ELEMENT DAMPER

(71) Applicant: VALEO EMBRAYAGES, Amiens (FR)

(72) Inventors: Eric RUMEAU, Cergy-Pontoise (FR); Herve MAHE, Cergy-Pontoise (FR); Roelof VERHOOG, Cergy-Pontoise (FR)

(73) Assignee: VALEO EMBRAYAGES, Amiens (FR)

(21) Appl. No.: 18/246,397

(22) PCT Filed: Mar. 23, 2023
(86) PCT No.: PCT/EP2021/077071

§ 371 Date: Mar. 23, 2023

(30) Foreign Application Priority Data
Oct. 1, 2020 (FR) 2010035

(51) Int. Cl. F16C 19/52; F16C 19/08; H02K 7/08

(52) U.S. Cl. CPC F16C 19/527; F16C 19/08; H02K 7/08; B60K 1/00

(57) ABSTRACT

A rolling bearing device for a mobility apparatus includes a first support, a second support, the first support and the second support being able to rotate with respect to one another. A first race that is able to be mounted fixedly in terms of rotation on the first support, and a second race is able to be mounted fixedly in terms of rotation on the second support. A damping device includes at least one elastic element disposed between the first support on one side and the first and the second race on the other side. The damping device also has a vibration dissipating member which is disposed between the first support and the elastic element, the vibration dissipating member being configured to dissipate the vibrations through shear.

The present invention relates to a rolling bearing device for a mobility apparatus. The invention relates in particular to the damping of vibrations to which an element that is able to rotate may be subjected. The invention also relates to a mobility apparatus comprising such a rolling bearing device, the mobility apparatus comprising an electric machine. The invention is applicable in particular in the field of motor vehicles, bicycles, scooters or two-wheeled motorcycles.

In a manner known per se, electric machines have a stator and a rotor comprising a rotor shaft. The stator is mounted in a casing configured to rotate the rotor shaft for example via rolling bearings.

FIG. 1 schematically shows an electric machine 1 according to the prior art. The electric machine 1 comprises a stator 3 and a rotor 4, which are mounted in a casing 2. The rotor 4 comprises a rotor shaft 5 extending coaxially with an axis of rotation X of the electric machine 1. The rotor 4 is mounted so as to be able to rotate on the casing 2 via a first rolling bearing 6 and a second rolling bearing 7. The first rolling bearing 6 and the second rolling bearing 7 each have an internal race and an external race. The internal race is mounted fixedly in terms of rotation on the rotor shaft 7 and the external race is mounted fixedly in terms of rotation on the casing 2.

In order for it to be possible to mount the first rolling bearing 6 and the second rolling bearing 7 on the casing 2 and on the rotor shaft 5, one of these rolling bearings is mounted with a clearance between the corresponding external race and the casing 2.

Thus, on account of this mounting with clearance of one of these rolling bearings 6 or 7 and/or on account of the electromagnetic forces of the electric machine 1, the rotor shaft 5 tends to move with radial movements. Such radial movements cause the electric machine 1 to shift, as depicted by way of dashed lines in FIG. 1. Such shifting generates vibrations and risks hindering the normal operation of the electric machine 1 and/or bringing about noise that is radiated by the structure of the electric machine 1.

To solve this problem, it is known practice to dispose an elastic elements such as 8 in the form of a wavy ring for example between the casing 2 and the first rolling bearing 6. This elastic element 8 is mounted more particularly in axial contact against the casing 2 and against one of the races of the first rolling bearing 6. However, the vibrations are not always damped enough.

The invention aims to solve this problem by proposing a rolling bearing device for reducing the amplitude of the radial movements undergone by a shaft around which a rolling bearing is mounted.

To this end, a subject of the invention is a rolling bearing device for a mobility apparatus, the rolling bearing comprising:
a first support,
a second support, the first support and the second support being able to rotate with respect to one another,
a first race that is able to mounted fixedly in terms of rotation on the first support,
a second race that is able to mounted fixedly in terms of rotation on the second support, and
a damping device comprising at least one elastic element disposed between the first support on one side and the first and the second race on the other side, wherein the damping device also has
a vibration dissipating member which is disposed between the first support and the elastic element or between the elastic element on one side and the first race and the second race on the other side, the vibration dissipating member being configured to dissipate the vibrations through shear.

Shear means an effect of a tangential force applied to a body in the plane of one of its faces. Shear also means a radial and/or axial shifting of a surface with respect to another surface, friction being generated between these two surfaces during this shifting.

In one example, there is shear between a first surface and a second surface which are in contact with one another and which are made to shift radially and/or axially with respect to one another.

According to one embodiment of the invention, the elastic element is disposed in contact against the first support and against one of the first race and/or the second race.

According to one embodiment of the invention, the dissipating member has at least two washers mounted in contact against the first support and against the elastic element.

In one exemplary embodiment of the invention, the washers have identical dimensions to one another.

In another example, the washers have dimensions that vary from one washer to another.

Each washer is placed in contact against another, adjacent washer such that the washers are able to rub against one another. The energy dissipated by the friction increases proportionally with respect to the number of surfaces. Thus, to dissipate the same quantity of energy, it will be possible to reduce a preload on the rolling bearing and thus to improve the effectiveness of power transmission. At the least, the surface exhibiting the least radial force will be the only one to move and to ensure the dissipation of energy; specifically, in a system in which the friction is too high, the movements are no longer possible and the transmission of forces takes place in its entirety.

In one example, the washers may be mounted axially and/or radially in contact against the elastic element.

According to one embodiment of the invention, two washers are stacked axially and/or or radially with respect to one another.

When the two washers are stacked axially with respect to one another, such a disposition creates four friction zones. The first is formed by the contact of the first support with one of the washers, the second is formed by contact of the two washers with one another and the third is formed by the contact of the other of the washers with the elastic element.

In another example, three washers are stacked axially, creating two friction zones of the washers with one another. Each of the friction zones is formed by a first surface of one of the washers and by a second surface of an adjacent washer, the first surface and the second surface facing one another and being made to rub radially against one another as a result of the vibrations to which the second support may be subjected.

According to one embodiment of the invention, the dissipating member has an elastomer material disposed between two washers.

According to one embodiment, the elastomer material and the two washers are mounted around the second support.

According to one embodiment, the elastomer material and the two washers each form a solid disk.

According to one embodiment of the invention, the washers are rotationally connected to the elastomer material. In one example, the washers are rotationally connected to the elastomer material by glue or by overmolding. Under the effect of vibrations, the two washers are disposed so as to be able to shift radially with respect to the elastomer material, bringing about elastic deformation of the elastomer material.

According to one embodiment of the invention, the washers are mounted in a floating manner with respect to the elastomer material. Under the effect of vibrations, the washers are made to rub the corresponding surface of the elastomer material while damping the vibrations.

According to one embodiment of the invention, the washers are made of steel.

According to one embodiment of the invention, the washers and the elastomer material each form a ring.

According to one embodiment of the invention, at least one of the washers forms a solid disk.

According to one embodiment of the invention, at least one of the washers forms a ring.

According to one embodiment of the invention, each of the washers is mounted around the second support with a first clearance J1 with respect to the first support and with a second clearance J2 with respect to the second support, the first clearance being smaller than the second clearance.

When an elastomer material is interposed between two washers, the elastomer material also forms a ring which is also configured with a first clearance J1 smaller than a second clearance J2.

According to one embodiment of the invention, the elastic element is formed by a Belleville-type washer.

According to one embodiment of the invention, the elastic element is mounted in contact against the external race.

According to one embodiment of the invention, the elastic element is formed by a crinkle washer.

According to one embodiment of the invention, the crinkle washer has at least two points of contact or two bosses, via which the crinkle washer is intended to come into contact with the dissipating member. In one example, the washer has five points of contact.

According to one embodiment of the invention, the dissipating member is of the Antiphon® MPM™ type, meaning that it is formed by a layer of polystyrene-butadiene-styrene copolymer with various additives inserted between two metallic membranes.

According to one embodiment of the invention, the elastic element and the dissipating member are made in one piece.

According to one embodiment of the invention, the dissipating member and the elastic element are in contact with one another via a plane-plane contact.

According to one embodiment of the invention, the dissipating member extends in a plane which is substantially perpendicular to an axis of rotation of the first race and of the second race.

According to one embodiment of the invention, the dissipating member extends circumferentially about an axis of rotation of the first race and of the second race. In this case, the race against which the elastic element or the dissipating member is positioned is advantageously mounted in a floating manner on the associated support while the other race is mounted fixedly in terms of rotation on the other associated support.
A further subject of the invention is a mobility apparatus comprising a rolling bearing device as described above, wherein the mobility apparatus is a motor vehicle comprising an electric machine.

A mobility apparatus means, inter alia, a motor vehicle, bicycle, scooter, two-wheeled motorcycle.

A further subject of the invention is a mobility apparatus comprising
an electric machine,
a first support and a second support, the first support and the second support being able to rotate with respect to one another, the first support being rotationally connected to the electric machine,
a first rolling bearing and a second rolling bearing, each being able to be mounted on one of the first support or the second support, respectively, the electric machine being located between the first rolling bearing and the second rolling bearing,
a first damping device disposed between one of the first support or the second support and the first rolling bearing, and
a second damping device disposed between one of the first support or the second support and the second rolling bearing,
each of the damping devices comprising at least one elastic element and a vibration dissipating member, the vibration dissipating member being configured to dissipate the vibrations through shear.

According to one embodiment of the invention, each of the damping devices is made in a form as mentioned above.

According to one embodiment of the invention, the first damping device has a stiffness K1 and the second damping device has a stiffness K2, the stiffness K1 and the stiffness K2 being different. In a preferred example, K1/K2 is equal to ½.

According to one embodiment of the invention, the first support may be formed by a first part on which the first rolling bearing is intended to be mounted and by a second part on which the second rolling bearing is intended to be mounted.

According to one embodiment of the invention, the first support forms one and the same part.

According to one embodiment of the invention, the elastic element of each of the damping devices is positioned between the rolling bearing and the vibration dissipating member or between one of the first support or the second support and the vibration dissipating member.

The invention will be understood better from reading the following description and examining the accompanying figures. These figures are provided only by way of entirely nonlimiting illustration of the invention.

FIG. 1 illustrates a schematic depiction of an electric machine, according to the prior art;

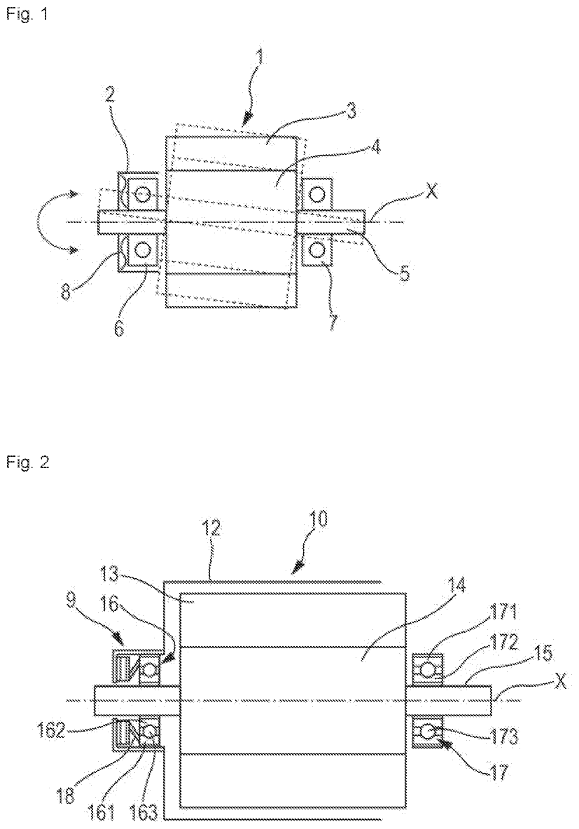

FIG. 2 illustrates a schematic depiction of an electric machine comprising a vibration dissipating member, according to a first embodiment of the invention;

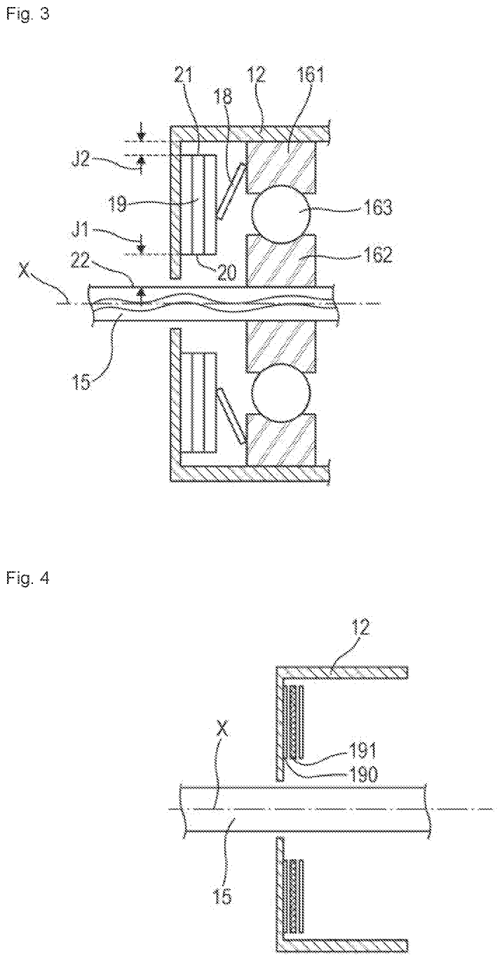

FIG. 3 illustrates a close-up of a part of FIG. 2;

FIG. 4 illustrates a vibration dissipating member, according to a second embodiment of the invention;

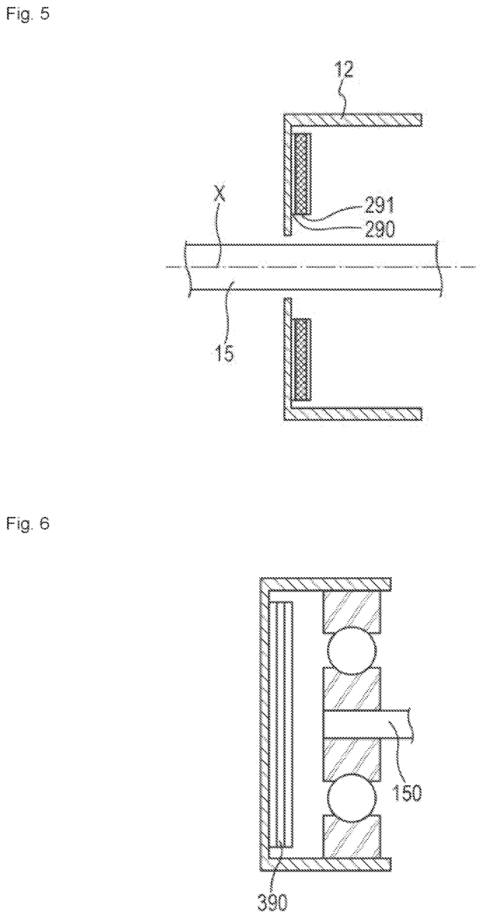

FIG. 5 illustrates a vibration dissipating member, according to a third embodiment of the invention;

FIG. 6 illustrates a vibration dissipating member, according to a fourth embodiment of the invention;

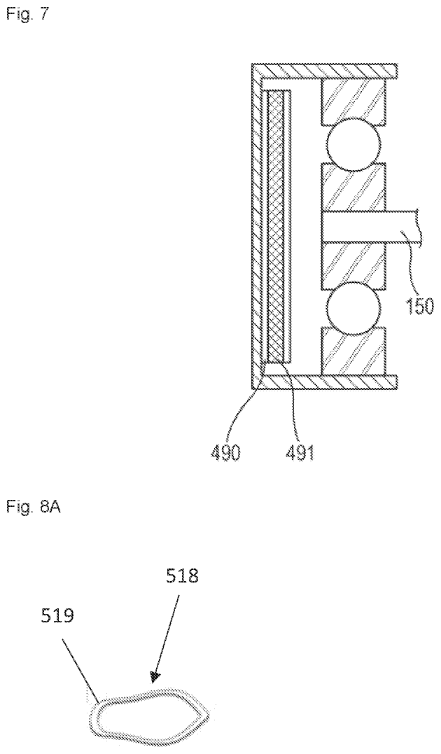

FIG. 7 illustrates a vibration dissipating member, according to a fifth embodiment of the invention;

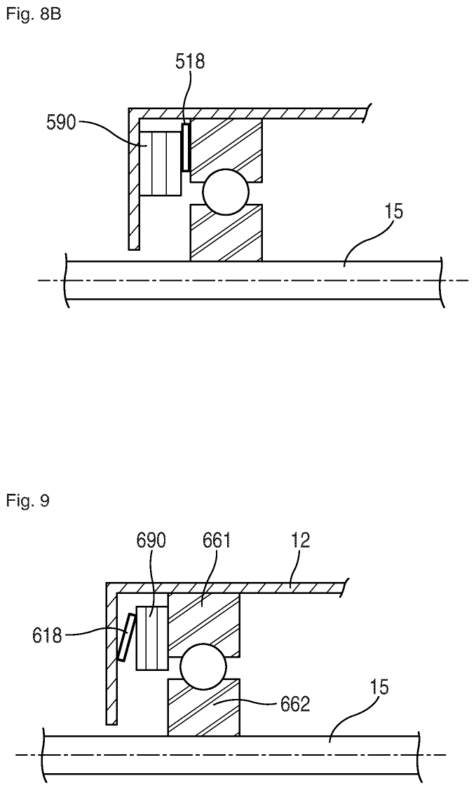

FIG. 8A illustrates an elastic element, according to a sixth embodiment of the invention;

FIG. 8B illustrates a damping device, according to the sixth embodiment of the invention;

FIG. 9 illustrates a damping device, according to a seventh embodiment of the invention;

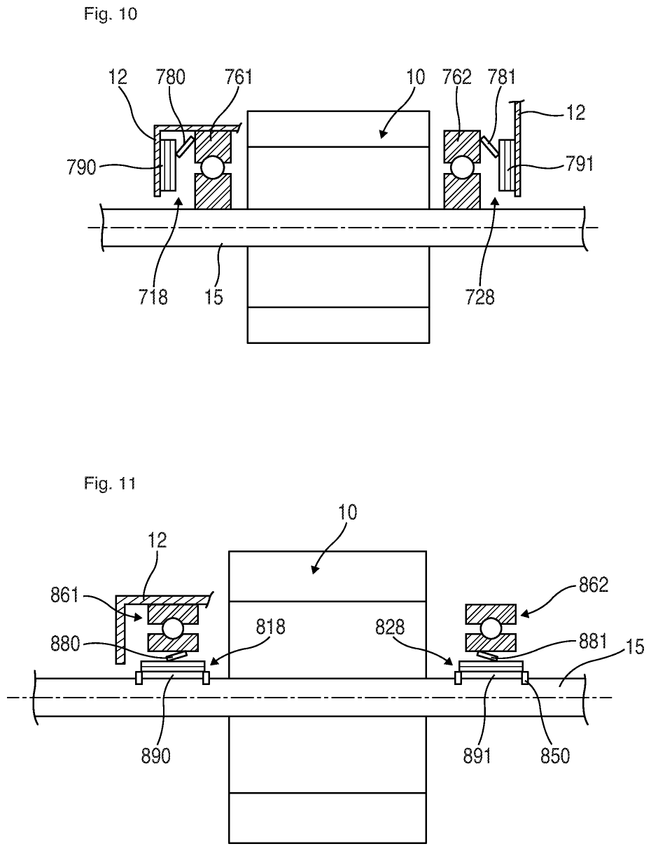

FIG. 10 illustrates a damping device, according to an eighth embodiment of the invention; and

FIG. 11 illustrates a damping device, according to the ninth embodiment of the invention.

In the description and the claims, the terms “external” and “internal” and the orientations “axial” and “radial” will be used. By convention, the “radial” orientation is orthogonal to the axial orientation. Depending on the context, the axial orientation relates to an axis of rotation of a shaft. The “circumferential” orientation is orthogonal to the axial direction and orthogonal to the radial direction. The terms “external” and “internal” are used to define the position of one element relative to another, with respect to the reference axis; an element close to the axis is thus referred to as internal, as opposed to an external element situated radially at the periphery.

Identical, similar or analogous elements retain the same references from one figure to another.

FIG. 2 shows an electric machine 10 for a motor vehicle (not shown), according to a first embodiment of the invention. The electric machine 10 has a casing 12, a stator 13 and a rotor 14. The casing 12 forms a protective shell for the stator 13 and the rotor 14. The rotor 14 has a rotor shaft 15 mounted centrally and coaxially with an axis of rotation X of the electric machine 10. The stator 13 and the rotor 14 is mounted on the casing 12 via a first rolling bearing 16 and a second rolling bearing 17. The first rolling bearing 16 and the second rolling bearing 17 are positioned axially on either side of the stator 13. The first rolling bearing 16 is mounted on a side close to an end of the rotor shaft 15 that is able to be fastened to a speed reducer (not shown), while the second rolling bearing 17 is mounted on another side of the rotor shaft 15 away from this same speed reducer. Each of the rolling bearings 16, 17 has an external race 161, 171 and an internal race 162, 172, which are disposed around the rotor shaft 15. The external race 161, 171 is rotationally connected to the casing 12, while the internal race 162, 172 is rotationally connected to the rotor shaft 15. Placed between these two races are balls such as 163, 173, ensuring the rotation of each of the external races and of the internal races with respect to one another.

Axially, between the casing 12 and the first rolling bearing 16, an elastic element 18 is disposed around the rotor shaft 15. This elastic element 18 may be a Belleville-type washer as illustrated, or a crinkle washer (shown in FIG. 8A).

According to this first embodiment of the invention, three washers such as 19 are disposed axially between the elastic element 18 and the casing 12. These washers 19 are disposed in a manner stacked one on top of another. In this example, they have identical dimensions to one another. These washers 19 each form a flat ring with a central orifice through which the rotor shaft 15 is inserted. The Belleville washer is disposed here in contact radially toward the outside against the external race 161 and radially toward the inside against one of the washers 19.

FIG. 3 illustrates the way in which the washers 19 are disposed according to this first embodiment of the invention. The washers 19 are stacked axially one with respect to another such that they can slide radially with respect to one another and generate friction in contact with one another. This friction makes it possible to dissipate the energy that has accumulated on account of the vibrations.

Each of the washers 19 has an inner perimeter 20 and an outer perimeter 21. Each of the washers 19 has a first maximum clearance J1 measured between the inner perimeter 20 and an external surface 22 of the rotor shaft 15. Each of the washers 19 has a second maximum clearance J2 measured between the outer perimeter 21 and the casing 12. A maximum clearance means the maximum possibility for each of the washers 19 to shift radially with respect to the rotor shaft 15. Each of these maximum clearances J1 and J2 is measured along one and the same axis which is orthogonal to the axis of rotation X. Thus, each of the washers 19 is produced such that the clearance J1 is larger than the clearance J2. Contact between a washer 19 and the rotor shaft 15 is thus always avoided.

In this example, the washers 19 are made of steel.

FIG. 4 illustrates a vibration dissipating member according to a second embodiment. According to this second embodiment, and as will be the case for the following figures, an elastic element, as illustrated at 18 in FIGS. 2 and 3, is also present, although it is not illustrated. A washer 191 made of elastomer material is placed between the two washers 190. The washers 190 have a structure and composition that are similar to those of the washers 19 in the first embodiment. In this example, the washers 190 and the washer 191 made of elastomer material are disposed alongside one another while being able to rub against one another radially under the action of the vibratory movements of the rotor shaft 15.

FIG. 4 shows washers 190, 191 that are spaced apart from one another in order to emphasize the fact that they are not bonded together, in contrast to what is described in FIG. 5.

FIG. 5 illustrates a vibration dissipating member according to a third embodiment of the invention. According to this third embodiment, a washer 291 made of elastomer material is disposed between two washers 290. In particular, the two washers 290 are bonded to the washer 291 made of elastomer material. The washers 290 and 291 have a structure and composition that are similar to those of the washers 190 and 191 in the second embodiment.

FIG. 6 illustrates a vibration dissipating member according to a fourth embodiment of the invention. According to this fourth embodiment, three washers 390 are disposed alongside one another while being able to slide radially with respect to one another. Each of these three washers 390 forms a solid disk. The three washers 390 are axially alongside one another while being able to shift radially with respect to one another. A rotor shaft 150 is illustrated, which does not pass through these same washers 390.

FIG. 7 illustrates a vibration dissipating member according to a fifth embodiment of the invention. According to this fifth embodiment, a washer 491 made of elastomer material is disposed between two washers 490. Each of these washers 491 and 490 forms a solid disk as in the previous example. These washers may be alongside one another while being able to shift radially with respect to one another. Alternatively, these washers may be bonded together without being able to rub against one another. As in the example in FIG. 6, the rotor shaft 150 does not pass through these same washers 490 and 491.

FIG. 8A shows another embodiment of the elastic washer. In particular, FIG. 8A illustrates an elastic crinkle washer 518 having bosses such as 519. In FIG. 8B, it is apparent that such an elastic washer 518 is placed, in operation, in contact with the vibration dissipating member 590 via a plane-plane contact.

FIG. 9 describes another disposition of the elastic washer with respect to the vibration dissipating member. In particular, according to this example, the elastic washer 618 is disposed between the casing 12 and the vibration dissipating member 690. Under these conditions, the vibration dissipating member 690 is mounted in contact against the external race 661. In another example, the vibration dissipating member 690 could be mounted in contact against the internal race 662.

FIG. 10 describes another example, in which a first rolling bearing 761 and a second rolling bearing 762 are disposed axially on either side of the electric machine 10. The expression “disposed axially” means disposed along an axis which is parallel to the axis of rotation X of the electric machine 10. In this example, the axis is coaxial with the axis of rotation X. A first damping device 718 of stiffness K1 and a second damping device 728 of stiffness K2 are disposed axially between the casing 12 and, respectively, the first rolling bearing 761 and the second rolling bearing 762.

The vibration dissipating member 790 of the first damping device 718 is disposed axially between the casing 12 and the first rolling bearing 761. A first elastic washer 780 is mounted axially between the first vibration dissipating member 790 and the first rolling bearing 761.
The vibration dissipating member 791 of the second damping device 728 is disposed axially between the casing 12 and the second rolling bearing 762. A second elastic washer 781 is mounted axially between the second vibration dissipating member 791 and the second rolling bearing 762.
In this preferred example, the first damping device 718 and the second damping device 728 are configured such that the stiffness K1 is twice as small as the stiffness K2.
For example, the washer 780 has a stiffness of 250 N while the washer 781 has a stiffness of 500 N. In this example, the casing 12 could be made of two separate parts (not shown). For example, the external race 762 could be mounted fixedly on a first part while the vibration dissipating member could be mounted fixedly on another part.

In another variant, FIG. 11 describes another disposition example. A first damping device 818 and a second damping device 828 are each disposed between the rotor shaft 15 and a corresponding rolling bearing 861, 862. Rather than being positioned axially between the casing 12 and the corresponding rolling bearing as illustrated in FIG. 10, each of the damping devices 818, 828 according to FIG. 11 is disposed radially between the rotor shaft 15 and the corresponding rolling bearing 861, 862. The expression “disposed radially” means disposed along an axis which perpendicularly intersects the axis of rotation X.

The vibration dissipating member 890 of the first damping device 818 is disposed so as to be mounted around the rotor shaft 15, between the rotor shaft 15 and the first rolling bearing 861. A first elastic washer 880 is mounted around the rotor shaft 15, between the first vibration dissipating member 890 and the first rolling bearing 861.

The vibration dissipating member 891 of the second damping device 828 is disposed so as to be mounted around the rotor shaft 15, between the rotor shaft 15 and the second rolling bearing 862. A second elastic washer 881 is mounted around the rotor shaft 15, between the second vibration dissipating member 891 and the second rolling bearing 862. In order to axially wedge the damping devices, circlips such as 850 may be mounted on the rotor shaft 15.

1. A rolling bearing device for a mobility apparatus, the rolling bearing device comprising:
a first support,
a second support, the first support and the second support being able to rotate with respect to one another,
a first race that is able to mounted fixedly in terms of rotation on the first support,
a second race that is able to mounted fixedly in terms of rotation on the second support, and
a damping device comprising at least one elastic element disposed between the first support on one side and the first and the second race on the other side, wherein the damping device also has
a vibration dissipating member which is disposed between the first support and the elastic element, the vibration dissipating member being configured to dissipate the vibrations through shear.

2. The rolling bearing device as claimed in claim 1, wherein the dissipating member has at least two washers mounted in contact against the first support and against the elastic element.

3. The rolling bearing device as claimed in claim 2, wherein the two washers are stacked axially with respect to one another.

4. The rolling bearing device as claimed in claim 2, wherein the dissipating member has an elastomer material disposed between the two washers.

5. The rolling bearing device as claimed in claim 4, wherein the washers are rotationally connected to the elastomer material.

6. The rolling bearing device as claimed in claim 4, wherein the washers are mounted in a floating manner with respect to the elastomer material.

7. The rolling bearing device as claimed in claim 2, wherein the washers are made of steel.

8. The rolling bearing device as claimed in claim 2, wherein at least one of the washers forms a ring.

9. The rolling bearing device as claimed in claim 2, wherein each of the washers forms a flat ring and is mounted around the second support with a first clearance J1 with respect to the first support and with a second clearance J2 with respect to the second support, the first clearance being smaller than the second clearance.

10. The rolling bearing device as claimed in claim 2, wherein at least one of the washers forms a solid disk.

11. The rolling bearing as claimed in claim 1, wherein the elastic element is formed by a Belleville-type washer.

12. The rolling bearing device as claimed in claim 1, wherein the first support is able to be rotationally connected to a stator of an electric machine.

13. A mobility apparatus comprising a rolling bearing as claimed in claim 1, wherein the mobility apparatus is a motor vehicle comprising an electric machine.

14. A mobility apparatus comprising
an electric machine,
a first support and a second support, the first support and the second support being able to rotate with respect to one another, the first support being rotationally connected to the electric machine,
a first rolling bearing and a second rolling bearing, each being able to be mounted on one of the first support or the second support, respectively, the electric machine being located between the first rolling bearing and the second rolling bearing,
a first damping device disposed between one of the first support or the second support and the first rolling bearing, and
a second damping device disposed between one of the first support or the second support and the second rolling bearing,
each of the damping devices comprising at least one elastic element and a vibration dissipating member, the vibration dissipating member being configured to dissipate the vibrations through shear.

15. The mobility apparatus as claimed in claim 14, wherein the first damping device has a stiffness K1 and the second damping device has a stiffness K2, the stiffness K1 and the stiffness K2 being different, for example K1/K2 being equal to ½.

16. The rolling bearing device as claimed in claim 3, wherein the washers are made of steel.

17. The rolling bearing device as claimed in claim 3, wherein at least one of the washers forms a ring.

18. The rolling bearing device as claimed in claim 3, wherein each of the washers forms a flat ring and is mounted around the second support with a first clearance J1 with respect to the first support and with a second clearance J2 with respect to the second support, the first clearance being smaller than the second clearance.

19. The rolling bearing device as claimed in claim 3, wherein at least one of the washers forms a solid disk.

20. The rolling bearing as claimed in claim 2, wherein the elastic element is formed by a Belleville-type washer.
